(19) United States
(12) Patent Application Publication
(10) Pub. No.: US 2010/0145906 A1
(43) Pub. Date: Jun. 10, 2010

(54) STORAGE METHOD

(75) Inventor: Thierry Milin, Trelevern (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 12/666,896

(22) PCT Filed: Jun. 25, 2008
(86) PCT No.: PCT/FR08/51154

§ 371 Date: Feb. 10, 2010

(30) Foreign Application Priority Data
Jun. 27, 2007 (FR) 07 56197

(51) Int. Cl. G06F 17/00; G06F 12/00; G06F 12/16

(52) U.S. Cl. 707/609; 707/695; 711/165; 707/E17.01; 711/E12.001; 711/E12.103; 711/E12.002; 711/171

(57) ABSTRACT

A method of storing a first version of a file in a first memory space, e.g. a mobile telephone is provided. The method includes: a step of sending from said first memory space to a second memory space an amount of data at least equal to the difference between the size of the first version of said file and the size of an available portion of said first memory space; a step of replacing a second version of said file with said first version; and a step of sending said amount of data back from said second memory space to said first memory space.

### CROSS REFERENCE TO RELATED APPLICATIONS

This application is the U.S. national phase of the International Patent Application No. PCT/FR2008/051154 filed Jun. 25, 2008, which claims the benefit of French Application No. 07 56197 filed Jun. 29, 2007, the entire content of which is incorporated herein by reference.

### BACKGROUND OF THE INVENTION

The present invention relates to a method of storing a first version of a file in a first memory space.

Such a method is known from the U.S. Patent Publication No. 2006/136548. This document describes a method of storing application software and data linked to the applications in a memory of a terminal, for example, a mobile telephone. The method of this document reserves a memory space that corresponds to the size of the application software concerned before the application software is sent to the memory of the mobile telephone. Thus if the application software has a size of 10 kilobytes (kB), the space reserved comprises 10 kB, or, if the application software has a size of 40 kB, the space reserved comprises 40 kB. The size of the reserved memory space is thus equal to the size of the application software. The application software is then stored in the memory space reserved in this way.

If there is insufficient space in the memory of the mobile telephone to enable reservation, for example, if the available space in the memory is only 20 kB and it is necessary to reserve 30 kB, reservation cannot be effected and the application and its data are therefore not stored. In the situation of a new version of an application that is to replace a current version, for example, in the context of updating that application, updating is therefore not possible. An example of this situation is updating firmware.

### SUMMARY

Consequently, the present invention aims to remedy the drawback referred to above by proposing an improved method of managing the space in a memory with a low storage capacity, such as that with which a mobile telephone is generally provided.

According to an embodiment of the invention, a method conforming to the introductory paragraph comprises:
a step of sending from said first memory space to a second memory space an amount of data at least equal to the difference between the size of said first version of said file and the size of an unoccupied part of said first memory space;
a step of replacing a second version of said file with said first version; and
a step of sending said amount of data back from said second memory space to said first memory space.

An embodiment of the invention particularly relates to a method of storing a first version (113) of a file (13) in a first memory space (11) comprising:

determining that the necessary amount of the first memory space (11) for receiving the first version of said file is no longer available, a step (311) of sending from said first memory space (11) to a second memory space (111) an amount of data at least equal to the difference between the size of said first version (113) of said file (13) and the size of an unoccupied part (19) of said first memory space (11);

replacing a second version of said file (13) with said first version (113); and

where applicable (i.e., if adequate space exists), sending said amount of data back from said second memory space (111) to said first memory space (11).

In this way, a file can be updated even if the memory of the terminal is completely full. It is no longer necessary to have a non-usable memory space that is free and reserved for updating files.

In one implementation of the invention, the method further comprises:
a step of verifying that said memory space (11) has a size at least equal to the size necessary to accommodate said first version (113) and said part occupied by said second version.

This step ensures that the method is not triggered if it is physically impossible, i.e., because of a lack of available space in the memory space.

In one implementation of the invention, said transmission step includes selecting data as a function of a label previously assigned to said data.

This has the advantage that data deemed sensitive by a user is not sent to the second memory space, which could, in particular, be on a temporary storage server outside the control of the user, for example. Thus the user can prevent a third party that has access to the storage server being able to access data that the user deems sensitive. Also, should the temporary storage server develop a fault during execution of the method, there will be no harmful consequences for this data.

An embodiment of the invention also provides a device adapted to be used in a method of storing a first version of a file in a first memory space, wherein the device comprises:
means for receiving from said first memory space an amount of data at least equal to the difference between the size of said first version of said file and the size of an unoccupied part of said first memory space; and
means for sending said amount of data back to said first memory space.

An embodiment of the invention further provides a communications device including a first memory space containing a second version of a file, wherein the device comprises:
means for sending from said first memory space to a second memory space an amount of data at least equal to the difference between the size of a first version of said file and the size of an unoccupied part of said first memory space;
means for replacing said second version of said file with said first version; and
means for receiving said amount of data from said second memory space.

An embodiment of the invention further provides a computer program including program code instructions for executing at least one of the steps of a method as described above when said program is executed on a computer.

An embodiment of the invention further provides a data medium containing a program as described above.

### BRIEF DESCRIPTION OF THE DRAWINGS

The invention can be better understood in the light of the following description, which is given by way of embodiments using non-limiting examples and with reference to the appended drawings, in which:

FIG. 1 is a block diagram illustrating in detail a drawback of the prior art;

FIG. 2 is a block diagram illustrating an embodiment of the invention; and

FIG. 3 is a timing diagram illustrating the steps of the method of the invention.

### DETAILED DESCRIPTION OF THE PREFERRED EMBODIMENTS

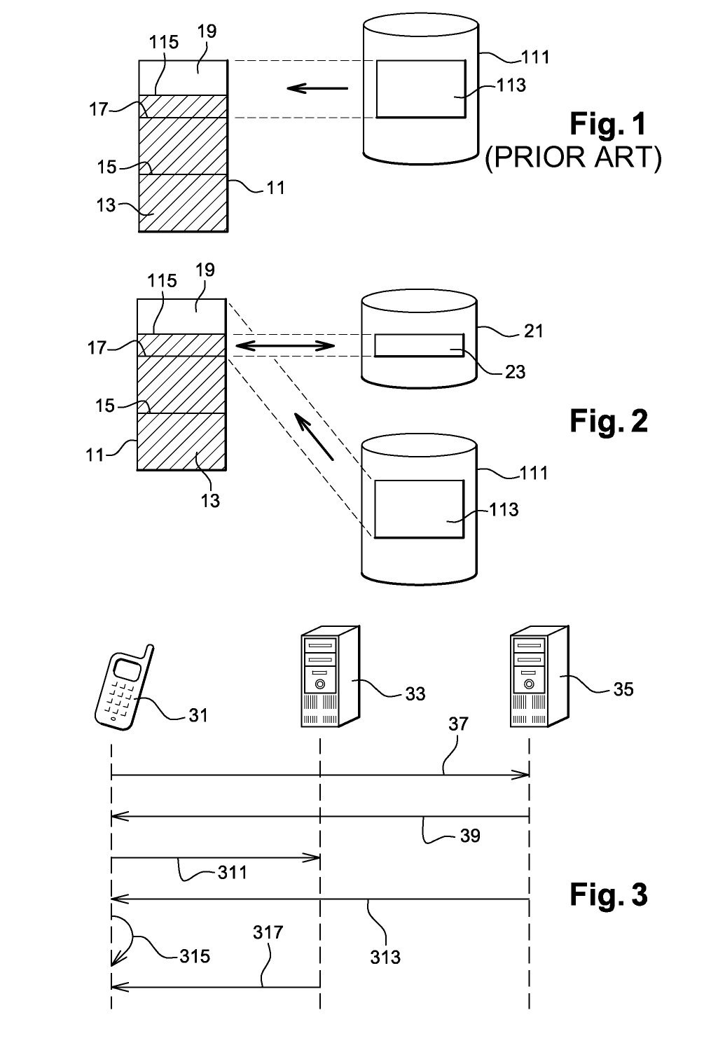

FIG. 1 represents diagrammatically a memory space 11 that can be provided in a terminal, for example, a mobile telephone. The memory space 11 comprises an occupied part (the shaded area up to the line 115) and an unoccupied or free part (the unshaded area 19). Application software and data collectively referred to below as files are stored in the occupied part. In the occupied part of the memory space 11 there is a current version of a file 13 that occupies the memory space 11 up to the line 15. The file 13 may consist of firmware, for example. Other files occupy the memory space 11 between the line 15 and the line 115. Each file has an identifier used to distinguish between the files (and the associated data). FIG. 1 also shows a memory 111, for example a hard disk of a content server, on which a new version 113 of the file 13 can be found. Before the new version 113 is sent to the memory space 11, memory management software attempts to reserve the corresponding necessary space. In the memory space 11 there is still the unoccupied part 19. However, to accommodate all of the new version 113 of the file 13 in the memory space 11 an additional amount of the memory space between the lines 115 and 17 is necessary. This amount is already occupied, however. When the management software finds that the necessary amount of the memory space 11 is not available, the new version is not sent.

This problem may be solved in the manner described with reference to FIG. 2. FIG. 2 additionally shows a memory 21, for example another hard disk in a temporary storage server. In the situation of the problem referred to with reference to FIG. 1, according to this embodiment of the invention, the amount of the memory space 11 that is occupied, i.e., the amount of the memory space between the lines 115 and 17, is sent to the memory 21 and stored therein as a file 23. In this way, the space between the line 115 and the line 17 becomes available for the new version 113 of the file 13 sent from the memory space 111. The management software then releases this amount in the memory space 11. Replacement entails replacing the current version of the file 13 in the memory space 11 with the new version 113. After replacement of the current version of the file 13 with the new version 113, the space between the line 17 and the line 115 can be used again. The file 23 is then sent back from the server 21 to this free space in the memory space 11.

The method of an embodiment of the invention is explained in detail with reference to FIG. 3. FIG. 3 shows a terminal 31 containing the memory 11, a temporary storage server 33 containing the memory 21, and a content server 35 containing the memory 111. The method commences with a request 37 from the terminal 31 to the first server 35 to send a new version of a file. This request contains an identifier that enables the server 35 to know which file is referred to. Then, during a transmission step 39, the first server 35 informs said terminal 31 of the amount of free memory space necessary for the first terminal 31 to be able to accommodate the new version of said file. It should be recalled that the memory space 11 of the terminal 31 comprises an occupied part and an unoccupied part. Only the unoccupied part is available to accommodate the new version of the file. Then, during a transmission step 311, data in the occupied part of the memory space 11 (the shaded area in FIG. 2) is sent from the memory space 11 to a second server 33. This amount of data is at least equal to the difference between the size of the new version of the file and the size of the unoccupied part of the memory space 11 (the non-shaded area in FIG. 2). The person skilled in the art understands that this amount of memory space must not be chosen from the memory space occupied by the current version of the file 13 if the file 13 is necessary for the operation of the terminal 31, for example if the file 13 contains firmware and the method is being used to update this firmware. However, this amount of memory space can be chosen from the memory space 11 occupied by other files (the memory space between the line 15 and the line 115 in FIG. 2).

An example illustrates the above description: if the unoccupied part of the memory space 11 comprises 80 kB but the new version of the file has a size of 130 kB, at least 130−80=50 kB of the occupied memory space must be sent to the second server 33. Thus 50 kB in the memory space 11 of the terminal 31 is freed and becomes available to accommodate the new version of the file 13 in its entirety.

During a transmission step 313, the new version is sent from said first server 35 to the part of the memory space released in this way and a priori unoccupied, i.e., not being used for the time being. Now two versions of the file 13 are present in the memory space 11: the current version and the new version 113. Then, during a step 315, the current version of the file already present in the terminal is replaced with the new version. Now the new version 113 of the file is present twice in the memory 11 and one version can therefore be sacrificed to accommodate the content of the memory space that was sent temporarily to the server 33.

During a retransmission step 317, this amount of data, i.e. in the present example 50 kB, is sent back from the second server 33 to a part of the memory space 11 occupied by one of the new versions.

The person skilled in the art understands that if the size of the new version of the file is different from the size of the current version an amount of memory that is no longer occupied in the memory space after execution of the method and is equal to the difference between the two sizes will, where applicable, become available.

In one implementation there is a preliminary step of verifying whether the memory of the terminal can accommodate the new version and the current version of the file at the same time, i.e., if the memory is large enough to accommodate the two versions simultaneously.

In one implementation all files present in the memory are provided with a numerical, alphanumerical or text identifier, for example “secret” or “personal”, when they are stored in the memory. Before the transmission step 311, a user can decide if they wish only their “personal” files to be sent to the memory 21 of the temporary storage server, and in particular not their “secret” files.

1-7. (canceled)

8. A method of storing a first version of a file in a first memory space, the method comprising:
determining that a necessary amount of the first memory space for receiving the first version of said file is no longer available;
sending from said first memory space to a second memory space an amount of data at least equal to a difference between a size of said first version of said file and a size of an unoccupied part of said first memory space;
replacing a second version of said file with said first version; and
sending said amount of data back from said second memory space to said first memory space if adequate space exists.

9. The method according to claim 8, further comprising:
verifying that said memory space has a size at least equal to the size necessary to accommodate said first version and said part occupied by said second version.

10. The method according to claim 8, wherein said transmission step includes selecting data as a function of a label previously assigned to said data.

11. A device for storing a first version of a file in a first memory space, wherein the device comprises:
means for receiving from said first memory space an amount of data at least equal to the difference between the size of said first version of said file and the size of an unoccupied part of said first memory space; and
means for sending said amount of data back to said first memory space.

12. A communications device including a first memory space containing a second version of a file, wherein the device comprises:
means for sending from said first memory space to a second memory space an amount of data at least equal to the difference between a size of a first version of said file and a size of an unoccupied part of said first memory space;
means for replacing said second version of said file with said first version; and
means for receiving said amount of data from said second memory space.

13. A computer program including program code instructions configured to run on a processor and for executing a method comprising:
determining that a necessary amount of the first memory space for receiving the first version of said file is no longer available;
sending from said first memory space to a second memory space an amount of data at least equal to a difference between a size of said first version of said file and a size of an unoccupied part of said first memory space;
replacing a second version of said file with said first version; and
sending said amount of data back from said second memory space to said first memory space if adequate space exists.

14. A computer data product comprising a computer usable medium having a computer readable program code embodied therein, said computer readable program code adapted to be executed to implement a method for storing a first version of a file in a first memory space, said method comprising:
determining that a necessary amount of the first memory space for receiving the first version of said file is no longer available;
sending from said first memory space to a second memory space an amount of data at least equal to a difference between a size of said first version of said file and a size of an unoccupied part of said first memory space;
replacing a second version of said file with said first version; and
sending said amount of data back from said second memory space to said first memory space if adequate space exists.
